(19) United States
(12) Patent Application Publication
(10) Pub. No.: US 2023/0206252 A1
(43) Pub. Date: Jun. 29, 2023

(54) SMART ANTI-COUNTERFEITING APPARATUS OF THE INTERNET OF THINGS AND AN ANTI-COUNTERFEITING METHOD OF SAME

(71) Applicant: SHANGHAI QINQI TECHNOLOGY CO., LTD, Shanghai (CN)

(72) Inventor: Wei SHI, Shanghai (CN)

(21) Appl. No.: 18/168,441

(22) Filed: Feb. 13, 2023

Related U.S. Application Data
(63) Continuation of application No. PCT/CN2020/112818, filed on Sep. 1, 2020.

(30) Foreign Application Priority Data
Aug. 19, 2020 (CN) 202010834901.6

(51) Int. Cl. G06Q 30/018; G16Y 40/50; B65D 55/14

(52) U.S. Cl. CPC G06Q 30/0185; G16Y 40/50; B65D 55/14

(57) ABSTRACT

A smart anti-counterfeiting apparatus and method of the Internet of Things comprise: an independent identification code; a PCB board for controlling a motor, and being arranged a chip having an independent MAC address; and a locking apparatus capable of one-time opening after closing; said locking apparatus includes: a rear shell, inside is arranged a motor, on the output shaft arranged with an external thread; a pushing piece, the middle portion provided with an internal thread hole to fit with the output shaft of the motor, and inside which there are several pushing piece thorough holes; a pressure plate arranged an outward convex receiving structure provided with a cavity to fit with the shape of said pushing piece; and a front shell, inside which are arranged several connecting columns fit with the pushing piece thorough holes, and the end of connecting columns being a step structure.

### FIELD OF THE INVENTION

The present invention relates to the technical field of the Internet of Things, in particular to a smart anti-counterfeiting apparatus of the Internet of Things and an anti-counterfeiting method thereof.

### BACKGROUND OF THE INVENTION

Traditional anti-counterfeiting technologies for valuables mainly include two-dimensional codes, RFID, NFC tags, etc., and these technologies are designed in view of increasing the cost of counterfeiting to achieve anti-counterfeiting to a certain extent. Due to the reason of information islands, digital signs such as two-dimensional codes, RFID, and NFC can theoretically be copied and decoded, and the costs to copy them are very low, thus a large number of anti-counterfeiting apparatus are recycled by counterfeiters for two-time use, so they cannot achieve anti-counterfeiting in a complete sense.

Currently, some anti-counterfeiting technologies for packages occurring to the products, like liquor, taken as an example, on the market, include laser printing, laser photolithography, laser hologram, etc., and are often applied in the outer packaging or inner packaging for the products, but because the packages for the bottles can be recycled, such anti-counterfeiting technologies cannot play a complete role in anti-counterfeiting. For example, the Chinese patent CN201220405310.8 discloses an NFC-based product information identification system, comprising a NFC terminal, a RF tag and a cloud computing server, wherein the NFC terminal is configured to send a request for inquiry into some kind of commodities to the RF tag, and send the anti-counterfeiting information encrypted by the RF tag to the cloud computing server; the RF tag is configured to receive the request for inquiry into commodities sent by the NFC terminal, read the anti-counterfeiting information according to a commodity category, and send the anti-counterfeiting information to the NFC terminal after encryption; the cloud computing server is configured to decrypt the above-mentioned encrypted anti-counterfeiting information, compare the decrypted anti-counterfeiting information with the locally-stored anti-counterfeiting information, judge the authenticity of the RF tag, and inform the NFC terminal of the final judgment result. This patent makes an anti-counterfeiting solution by means of the RF tag and the NFC terminal, but the RF tag is arranged on the outer package or the shell of the product, in case of recycling the outer package or the shell of the product, it cannot achieve an anti-counterfeiting effect.

In order to solve the above problem, a Chinese patent application CN2014207856812 discloses an anti-counterfeiting bottle cap of the Internet of Things, which achieves an anti-counterfeiting effect by combining network verification with usage of local passwords, but the problem how to recycle and reproduce the bottle cap with a password lock is still not solved, so counterfeiters easily obtain the local password, and are costed less to counterfeit an electronic label.

Another Chinese patent CN201420011975X discloses an anti-counterfeiting wine bottle of the Internet of Things, which comprises a wine bottle body and a shell, wherein the wine bottle body has a upper bottle body and a lower bottle body combined with each other, a control apparatus, a locking apparatus and a battery are arranged inside the shell, the control apparatus is connected to a host of a remote certification center through a network, the control apparatus and the locking apparatus are connected with each other by a circuit, the locking apparatus enables the upper bottle body to be fixed with the lower bottle body, and the battery is connected to the control apparatus and the locking apparatus through a circuit, respectively. The anti-counterfeiting wine bottle of the Internet of Things in this invention must be authenticated online and initiated remotely by an external action, so that an original imitation made by counterfeiters or a recycled bottle used by counterfeiters to counterfeit cannot be certified by the certification center, and ultimately leads to the inability to counterfeit. This patent has two defects: 1. the bottle itself is made up by the upper bottle body and the lower bottle body which can open and close by means of a remote control, but for much liquor a ceramic bottle is used as a packaging container due to its most notable feature that it has a certain degree of breathability, which has great benefits for the later natural fermentation of liquor, therefore, it is difficult to popularize the bottle body controllably to open and close; 2. the patented wine bottle can be cleaned and disinfected for reuse, so the anti-counterfeiting bottle risks itself a lot, because after recycling the bottle body controllably to open and close, counterfeiters can remake a set of remote control systems to achieve a counterfeiting effect.

Still another Chinese patent 201610731176.3 discloses an anti-counterfeiting authentication method for the wine industry based on a NFC chip, which comprise the following steps. On an enterprise's commodity management platform, a manufacturer writes product information, batch information, and product serial number information to the NFC tag by means of a card writer and simultaneously uploads them to a cloud server. The NFC tag has built-in UID information. This patent has the advantages as follows: by making uses of the security of the NFC chip and the structure easy to tear, we can create a high-safe anti-counterfeiting technology for wine packages. This patent has the disadvantages as follows: for much liquor a ceramic bottle is used as a packaging bottle, so it is difficult for ordinary consumers to discover that counterfeiters may dill the ceramic bottle body and then repair it, and it is easy for counterfeiters to replace the genuine bottle with a counterfeit bottle.

### SUMMARY OF THE INVENTION

The present invention aims to solve the defects of the prior art, so it provides a smart anti-counterfeiting apparatus of the Internet of Things and an anti-counterfeiting method thereof.

In order to achieve the above objective, we provide a smart anti-counterfeiting apparatus of the Internet of Things, which at least includes:

an independent identification code;

a PCB board, which is used to control a motor, and on which is arranged a chip having an independent MAC address;

and a locking apparatus only capable of one-time opening after closing;

wherein, the locking apparatus includes:

a rear shell, inside which is arranged a motor, on the output shaft of which an external thread is arranged;

a pushing piece, the middle portion of which is provided with an internal thread hole to fit with the output shaft of the motor, and inside which there are several pushing piece thorough holes;

a pressure plate, on which is arranged an outward convex receiving structure provided with a cavity to fit with the shape of the pushing piece and used to prevent the rotation trend of the pushing piece; and

a front shell, inside which are arranged several connecting columns which fit with the pushing piece thorough holes, the ends of which are a step structure which is jammed in the pushing piece thorough hole after the connecting column passes through the push piece thorough hole, which are made of plastic, and the ends of which can produce a certain deformation, so that the step structure of the ends can be pressed into the pushing piece thorough hole.

We provide another smart anti-counterfeiting apparatus of the Internet of Things with better stability, which at least includes:

an independent identification code;

a PCB board, which is used to control a motor, and on which is arranged a chip having an independent MAC address;

and a locking apparatus only capable of one-time opening after closing.

wherein, the locking apparatus includes:

a rear shell, inside which is arranged a motor on the output shaft of which an external thread is arranged;

a pushing piece, the middle portion of which is provided with an internal thread hole to fit with the output shaft of the motor, and inside which there are several pushing piece thorough holes;

a pressure plate, on which is arranged an outward convex receiving structure provided with a cavity to fit with the shape of the pushing piece and used to prevent the rotation trend of the pushing piece, and on which are arranged several guiding holes; at least one guiding holes being arranged in the lower portion of the pressure plate;

a front shell, inside which are arranged several connecting columns and several guiding columns; the connecting columns fitting with the pushing piece thorough holes, the end of the connecting columns being a step structure which is jammed in the pushing piece thorough holes after the connecting columns pass through the push piece thorough holes, at least one guiding columns being arranged in the lower portion of the front shell and fitting with the position of the guiding hole of the pressure plate, and the middle portion of at least one guiding columns being provided with a step structure; and

a clamping plate, which is arranged between the front shell and the pressure plate, and on which are arranged several clamping plate through-holes and several clamping plate guiding holes which correspond to the pushing piece thorough-holes and the guiding columns of the front shell, respectively; the step structure at the middle portion of the guiding columns of the front shell only fitting with the clamping plate guiding holes. The end of the guiding column is a step structure, and after the guiding column passes through the pressure plate thorough hole, the step structure at the guiding column end is jammed in the pressure plate thorough hole, the end and middle portion of at least one guiding column are both a step structure, the step structure of the end fits with a pressure plate guiding hole, and the step structure of the middle portion fits with the clamping plate guiding hole.

Preferably, a battery or a charging interface is arranged inside the smart anti-counterfeiting apparatus of the Internet of Things, and the charging interface is used to connect an external power supply.

Preferably, a positioning piece fitting with the rabbet of a pressure plate receiving structure is arranged on the pushing piece, and further limits the rotation trend of the pushing piece.

Preferably, several guiding columns are further arranged inside the front shell, and several corresponding pressure plate thorough holes are arranged on the pressure plate.

Preferably, the end of the guiding column is a step structure, and after the guiding column passes through the pressure plate thorough hole, the step structure at the end of the guiding column is jammed in the pressure plate thorough hole.

Preferably, the anti-counterfeiting apparatus further includes an anti-counterfeiting film, a portion of which is arranged inside the locking apparatus.

Preferably, the motor is a unidirectional motor.

Preferably, the smart anti-counterfeiting apparatus of the Internet of Things further includes an independent SN code.

Preferably, the identification code is arranged at the junction of the front shell and the rear shell, and the identification code can be destroyed in case that the front shell and the rear shell separate from each other.

We provide an anti-counterfeiting method based on the smart anti-counterfeiting apparatus of the Internet of Things, wherein the smart anti-counterfeiting apparatus of the Internet of Things communicates with an user's mobile phone, and the user's mobile phone communicates with a cloud server, comprising the following steps:

S1. scanning the independent identification code of the smart anti-counterfeiting apparatus of the Internet of Things through an user's mobile terminal;

S2. obtaining an ID number, then requesting a back-end server to obtain the unlock information of the ID number corresponding to the ID number through the network;

S3. enabling the back-end server to process the information of the ID number, if such a number does not exist in the back-end server, presenting the ID as a failure; if such a number exists in the back-end server but unlock information has occurred, presenting the ID as invalidity; if such a number exists in the back-end server and unlock information does not occur, returning the hardware information, Mac address, SN number and unlock code of the smart anti-counterfeiting apparatus of the Internet of Things to the user's mobile terminal;

S4. enabling the user's mobile terminal to connect to the smart anti-counterfeiting apparatus of the Internet of Things and send an unlock command by means of wireless connection through the Mac address, and verifying the identity permission through encryption required for the connection of the user's mobile terminal with the smart anti-counterfeiting apparatus of the Internet of Things and the dispatch of commands; and

S5. enabling the user's mobile terminal to submit the apparatus's Mac address and the SN number to the back-end server after informed of successful unlocking, then the back-end server to set the Mac address and the SN number to be an unlocked state, and return to an invalid state at next scanning, meanwhile enabling the hardware apparatus to perform a destruction procedure after feedbacking successful unlock information, so as to ensure no two-time utilization.

We provide another anti-counterfeiting method based on the smart anti-counterfeiting apparatus of the Internet of Things, wherein the smart anti-counterfeiting apparatus of the Internet of Things communicates with an user's mobile phone, and the user's mobile phone communicates with a cloud server, comprising the following steps:

S1. scanning the independent identification code of the smart anti-counterfeiting apparatus of the Internet of Things through an user's mobile terminal;

S2. obtaining an ID number, then requesting a back-end server to unlock through the network;

S3. enabling the back-end server to process the information of the ID number, if such a number does not exist in the back-end server, presenting the ID as a failure; if such a number exists in the back-end server but unlock information has occurred, presenting the ID as invalidity; if such a number exists in the back-end server and unlock information does not occur, returning the hardware information, Mac address, SN number and unlock code of the smart anti-counterfeiting apparatus of the Internet of Things to the user's mobile terminal;

S4. enabling the user's mobile terminal to connect to the smart anti-counterfeiting apparatus of the Internet of Things and send an unlock command by means of wireless connection through the Mac address; and

S5. enabling the back-end server to set the Mac address and the SN number to be an unlocked state after informed of successful unlocking, and return to an invalid state at next scanning, meanwhile enabling the hardware apparatus to perform a destruction procedure after feedbacking successful unlock information, so as to ensure no two-time utilization.

The smart anti-counterfeiting apparatus of the Internet of Things may be completely separated, comprising the following steps:
a. encapsulating an anti-counterfeiting film on the outside of a product to be anti-counterfeited;
b. connecting the internal thread hole of the pushing piece with the external thread of the motor on the rear shell, and matching and connecting the pressure plate with the pushing piece by means of the receiving structure;
c. assembling and connecting the rear shell, the pushing piece and the pressure plate that have been connected together with the front shell at an appropriate position of the product that needs to be anti-counterfeited, matching and connecting the connecting column of the front shell with the pushing piece thorough hole, enabling the end of the connecting column to be a step structure, in case that the connecting column of the front shell passes through the pushing piece thorough hole, jamming the step structure at the end of the connecting column in the pushing piece thorough hole to enable the smart anti-counterfeiting apparatus of the Internet of Things to lock a portion of the anti-counterfeiting film after installation;
d. after the motor receives unlock information, enabling the output shaft of the motor to rotate in an unidirectional direction to drive the pushing piece, which cannot rotate under the position limit of the pressure plate, to move transversely relative to the motor, jamming the rear end of the connecting column of the front shell in the pushing piece thorough hole, meanwhile enabling the front shell to move transversely relative to the motor and the rear shell until the pushing piece and the front shell separate from the rear shell; thus opening the smart anti-counterfeiting apparatus of the Internet of Things; and
e. at this time, still connecting the pushing piece together with the front shell, still jamming the connecting column of the front shell in the pushing piece thorough hole, stilling putting the pushing piece under the position limit of the pressure plate receiving structure, so that the internal thread hole of the pushing piece cannot be connected with the external thread of the motor on the rear shell again.

The smart anti-counterfeiting apparatus of the Internet of Things cannot be completely separated, comprising the following steps:
a. encapsulating an anti-counterfeiting film on the outside of a product to be anti-counterfeited;
b. connecting the internal thread hole of the pushing piece with the external thread of the motor on the rear shell, and matching and connecting the pressure plate with the pushing piece by means of the receiving structure, and enabling the guiding column of the rear shell to pass through the pressure plate thorough hole;
c. assembling and connecting the rear shell, the pushing piece and the pressure plate that have been connected together with the front shell at an appropriate position of the product that needs to be anti-counterfeited, matching and connecting the connecting column of the front shell with the pushing piece thorough hole, enabling the end of the connecting column to be a step structure, in case that the connecting column of the front shell passes through the pushing piece thorough hole, jamming the step structure at the end of the connecting column in the pushing piece thorough hole to enable the smart anti-counterfeiting apparatus of the Internet of Things to lock a portion of the anti-counterfeiting film after installation;
d. after the motor receives unlock information, enabling the output shaft of the motor to rotate in an unidirectional direction to drive the pushing piece, which cannot rotate under the position limit of the pressure plate, to move transversely together with the pressure plate relative to the motor, jamming the rear end of the connecting column of the front shell in the pushing piece thorough hole, meanwhile enabling the front shell to move transversely relative to the motor and the rear shell until the end of the guiding column is jammed in the pressure plate thorough hole, so that the pushing piece and the front shell move over a distance relative to the rear shell; thus opening the smart anti-counterfeiting apparatus of the Internet of Things; and
e. at this time, still connecting the pushing piece together with the front shell, still jamming the connecting column of the front shell in the pushing piece thorough hole, stilling putting the pushing piece under the position limit of the pressure plate receiving structure, so that the internal thread hole of the pushing piece cannot be connected with the external thread of the motor on the rear shell again.

The anti-counterfeiting apparatus of the Internet of Things with better stability may be completely detachable, comprising the following steps:
a. encapsulating an anti-counterfeiting film on the outside of a product to be anti-counterfeited;
b. connecting the internal thread hole of the pushing piece with the external thread of the motor on the rear shell, and matching and connecting the pressure plate with the pushing piece by means of the receiving structure;
c. aligning the clamping plate guiding hole with the guiding holes of the pressure plate;
d. assembling and connecting the rear shell, the pushing piece, the pressure plate and the clamping plate that have been connected together with the front shell at an appropriate position of the product that needs to be anti-counterfeited, matching and connecting the connecting column of the front shell with the pushing piece thorough hole, enabling the end of the connecting column to be a step structure, in case that the connecting column of the front shell passes through the pushing piece thorough hole, jamming the step structure at the end of the connecting column in the pushing piece thorough hole; enabling the guiding column of the front shell to pass through the pressure plate and the clamping plate guiding hole, and arranging a step structure capable of clipping the clamping plate after passing through the clamping plate guiding hole, at the middle portion of at least one guiding column, so that the smart anti-counterfeiting apparatus of the Internet of Things locks a portion of the anti-counterfeiting film after installation;
e. after the motor receives unlock information, enabling the output shaft of the motor to rotate in an unidirectional direction to drive the pushing piece, which cannot rotate under the position limit of the pressure plate, to move transversely relative to the motor, jamming the rear end of the connecting column of the front shell in the pushing piece thorough hole and jamming the step structure of the middle portion of the guiding column of the front shell in the clamping plate guiding hole; meanwhile enabling the clamping plate and the front shell to move transversely relative to the motor and the rear shell until the pushing piece and the front shell separate from the rear shell; thus opening the smart anti-counterfeiting apparatus of the Internet of Things; and
f. at this time, still connecting the pushing piece together with the front shell, still jamming the connecting column of the front shell in the pushing piece thorough hole, still jamming the guiding column of the front shell in the clamping plate guiding hole, stilling putting the pushing piece under the position limit of the pressure plate receiving structure, so that the internal thread hole of the pushing piece cannot be connected with the external thread of the motor on the rear shell again.

The anti-counterfeiting apparatus of the Internet of Things with better stability cannot be detachable, comprising the following steps:
a. encapsulating an anti-counterfeiting film on the outside of a product to be anti-counterfeited;
b. connecting the internal thread hole of the pushing piece with the external thread of the motor on the rear shell, and matching and connecting the pressure plate with the pushing piece by means of the receiving structure;
c. aligning the clamping plate guiding hole with the guiding holes of the pressure plate;
d. assembling and connecting the rear shell, the pushing piece, the pressure plate and the clamping plate that have been connected together with the front shell at an appropriate position of the product that needs to be anti-counterfeited, matching and connecting the connecting column of the front shell with the pushing piece thorough hole, enabling the end of the connecting column to be a step structure, in case that the connecting column of the front shell passes through the pushing piece thorough hole, jamming the step structure at the end of the connecting column in the pushing piece thorough hole; enabling the guiding column of the front shell to pass through the pressure plate and the clamping plate guiding hole, arranging a step structure capable of clipping the pressure plate after passing through the pressure plate guiding hole, at the end of the guiding column, and arranging a step structure at the middle portion and the end of at least one guiding column to enable the step structure at the middle portion to clip the clamping plate after passing through the clamping plate guiding hole, so that the smart anti-counterfeiting apparatus of the Internet of Things locks a portion of the anti-counterfeiting film after installation;
e. after the motor receives unlock information, enabling the output shaft of the motor to rotate in an unidirectional direction to drive the pushing piece, which cannot rotate under the position limit of the pressure plate, to move transversely relative to the motor, jamming the rear end of the connecting column of the front shell in the pushing piece thorough hole and jamming the step structure of the middle portion of the guiding column of the front shell in the clamping plate guiding hole; meanwhile enabling the front shell and the clamping plate to move transversely relative to the motor and the rear shell until the end of the guiding column is jammed in the pressure plate thorough hole, so that the pushing piece and the front shell move over a distance relative to the rear shell; thus opening the smart anti-counterfeiting apparatus of the Internet of Things; and
f. at this time, still connecting the pushing piece together with the front shell, still jamming the connecting column of the front shell in the pushing piece thorough hole, still jamming the guiding column of the front shell in the clamping plate guiding hole, stilling putting the pushing piece under the position limit of the pressure plate receiving structure, so that the internal thread hole of the pushing piece cannot be connected with the external thread of the motor on the rear shell again.

We provide an smart anti-counterfeiting apparatus of the Internet of Things with another structure, which at least includes:

an independent identification code;

a PCB board, which is used to control a motor, and on which is arranged a chip having an independent MAC address;

and a locking apparatus only capable of one-time opening after closing.

wherein, the locking apparatus includes:

a rear shell, inside which a motor is arranged;

a facility pressure plate, on which is arranged a facility pressure plate thorough hole used to let the output shaft of the motor to pass through, and on which are arranged several transmission screws driven through the interactional movement between the output shaft of the motor and a transmission apparatus;

several pushing pieces, inside which is arranged an internal threaded hole fitting with the transmission screw, and on which several pushing piece thorough holes are arranged;

a guiding pressure plate, on which are arranged several protuberant guiding pressure plate receiving structure the inner cavities of which fit with the pushing pieces so as to limit the rotation of the pushing pieces; and

a front shell, inside which are arranged several connecting columns which fit with the pushing piece thorough holes, and the end of connecting columns being a step structure which is jammed in the pushing piece thorough holes after the connecting columns pass through the push piece thorough holes.

Preferably, the transmission apparatus is an annular transmission toothed belt, which meshes with the gear of the output shaft of the motor, and simultaneously meshes with the gears of several transmission screws.

Preferably, the anti-counterfeiting apparatus further includes a transmission compartment pressure plate, the annular transmission toothed belt simultaneously meshes with four transmission screws arranged on the facility pressure plate, the transmission compartment pressure plates are arranged above the annular transmission toothed belt, a transmission compartment pressure plate gap composed of a hole or a groove or a notch is arranged on the transmission compartment pressure plate, the transmission screws pass through the transmission compartment pressure plate gap and are connected to the internal threaded hole of the pushing piece.

Preferably, a battery or a charging interface is arranged inside the smart anti-counterfeiting apparatus of the Internet of Things, and the charging interface is used to connect an external power supply.

Preferably, the anti-counterfeiting apparatus further includes an anti-counterfeiting film, a portion of which is arranged inside the locking apparatus.

Preferably, the motor is a unidirectional motor.

Preferably, the smart anti-counterfeiting apparatus of the Internet of Things also includes an independent SN code.

Preferably, the identification code is arranged at the junction of the front shell and the rear shell, and the identification code can be destroyed in case that the front shell and the rear shell separate from each other.

We provide an smart anti-counterfeiting apparatus of the Internet of Things with the second structure, comprising the following steps:
a. putting a facility pressure plate cover above the rear shell, and enabling the output shaft of the motor of the rear shell to pass through the facility pressure plate;
b. installing the annular transmission toothed belt above the facility pressure plate cover, meshing the annular transmission toothed belt with the gear of the output shaft of the motor, and simultaneously with the gears of several transmission screws, and enabling the output shaft of the motor to rotate, so as to drive all transmission screws to rotate;
c. installing the transmission compartment pressure plate above the annular transmission toothed belt, and connecting the transmission screw to the pushing piece through the transmission compartment pressure plate;
d. assembling and connecting the pushing piece with the guiding pressure plate receiving structure; and
e. connecting the pushing piece with the front shell at an appropriate position of the product that needs to be anti-counterfeited, so as to close the apparatus; during operation, enabling the output shaft of the motor to rotate and drive the transmission screws to rotate, enabling the guiding pressure plate to limit the rotation of the pushing piece through the rotation of the transmission screws, enabling the transmission screws to rotate to drive the pushing piece to move upwards, and enabling the pushing piece to move upwards together with the the clamping plate and the front shell under the action of the connecting column, so that the pushing piece and the front shell separate from the rear shell, the facility pressure plate, the annular transmission toothed belt and the transmission compartment pressure plate, so as to open the apparatus, at this time, still connecting the pushing piece together with the front shell, still jamming the connecting column of the front shell in the pushing piece thorough hole, stilling putting the pushing piece under the position limit of the pressure plate receiving structure, so that the internal thread hole of the pushing piece cannot be connected with the external thread of the motor on the rear shell again.

Compared with the prior art, the present invention has the following advantages.
1. Locking the front shell and the rear shell relies on the principle of mechanical physics, so it can be suitable for automatic rapid installation for enterprise's assembly line, without manual intervention to use any electronic apparatus for locking, thereby preventing the possibly existing risk from leaking.
2. The manufacturers for anti-counterfeiting apparatuses are only responsible for hardware production, and the manufacturers for products themselves perform operations such as importing SN+MAC into a back-end database and making an identification code, so the present invention can completely prevents the manufacturers for anti-counterfeiting apparatuses from privately distributing products and data, resulting in the failure of anti-counterfeiting functions.
3. The MAC address, SN number and identification code of each anti-counterfeiting apparatus are unique, and they are all encrypted by means of encryption.
4. This anti-counterfeiting apparatus cannot be reused after one-time opening. Even if counterfeiters remove the rear shell to obtain the PCB, the remade PCB cannot be used, for the reason that the MAC address, SN number, and identification code data of each anti-counterfeiting apparatus are unique, must exist in the back-end server of the manufacturer for products, have been activated, and operate only by adopting the unique registered APP of the manufacturer for products. Even if counterfeiters buy electronic components from an electronics market to make a new PCB, the MAC addresses of these components cannot be imported into the back-end server of the manufacturer for products, and counterfeiters cannot register the APP of the manufacturer for products.

### BRIEF DESCRIPTION OF THE DRAWINGS

FIG. 1 is an exploded view of Example 1 of the present invention.

FIG. 2 is another exploded view of Example 1 of the present invention.

FIG. 3 shows how to match the front shell with the pushing piece in Example 1 of the present invention.

FIG. 4 shows the front shell and the pushing piece matched with each other in Example 1 of the present invention.

FIG. 5 shows an opening state of Example 2 of the present invention.

FIG. 6 shows a before-use state of Example 3 of the present invention.

FIG. 7 shows an opening state of Example 3 of the present invention.

FIG. 8 is an exploded view of Example 4 of the present invention.

FIG. 9 is another exploded view of Example 4 of the present invention.

FIG. 10 is an exploded view of Example 5 of the present invention.

FIG. 11 is another exploded view of Example 5 of the present invention.

FIG. 12 is an assembly diagram of Example 5 of the present invention.

Wherein, 1—rear shell; 1-1—motor; 1-2—external thread; 2—pressure plate; 2-1—receiving structure; 2-2—rabbet; 2-3—pressure plate thorough hole; 2-4—guiding hole; 3—pushing piece; 3-1—internal thread hole; 3-2—pushing piece thorough hole; 3-3—positioning piece; 4—front shell; 4-1—connecting column; 4-2—guiding column; 4-3—guiding column end; 5—facility pressure plate; 5-1—facility pressure plate thorough hole; 5-2—transmission screw; 6—transmission toothed belt; 7—transmission compartment pressure plate; 7-1—transmission compartment pressure plate gap; 8—watch; 9—guiding pressure plate; 9-1—guiding pressure plate receiving structure; 10—clamping plate; 10-1—clamping plate thorough hole; 10-2—clamping plate guiding hole.

### DETAILED DESCRIPTION OF SOME EMBODIMENTS

We shall further describe the present invention in combination with the drawings as follows, and it is obvious for a person skilled in the art to understand the structure and principle of the present invention. It is understandable that the specific examples described herein are only used to explain the present invention and are not intended to pose a limitation on the present invention.

### Example 1

As shown in FIGS. 1 and 2, the motor 1-1 and a PCB control board are arranged inside the cavity of the rear shell 1 according to the present invention, and a battery to power the motor and the PCB control board or a preset charging interface to power the motor and the PCB control board from an external power supply may be arranged inside the rear shell, and a chip having an independent MAC address is also arranged on the PCB control board.

One side of the front portion of the pressure plate 2 according to the present invention is the outward-convex receiving structure 2-1 inside which a cavity is arranged, the rabbet 2-2 is further arranged at one side of the cavity, several pressure plate thorough holes 2-3 are arranged on the pressure plate, and the groove in the lower portion of the pressure plate in this example is used to fit with a bottle cap.

The internal thread hole 3-1 used to fit with the output shaft of the motor of the rear shell is arranged at the middle portion of the pushing piece 3 according to the present invention, two pushing piece thorough holes 3-2 are arranged inside the pushing piece, and the positioning piece 3-3 is arranged at the bottom of the pushing piece.

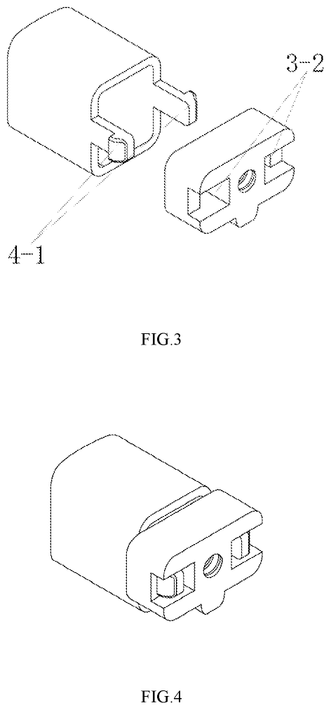

Two connecting columns 4-1 connected with the pushing piece thorough hole 3-2 are arranged inside the front shell 4 according to the present invention. As shown in FIGS. 3 and 4, the ends of the connecting columns 4-1 are a step structure, the front cross-sectional area of which is smaller than its rear cross-sectional area, after the connecting columns 4-1 pass through the pushing piece thorough holes 3-2, the rear ends of the connecting columns 4-1 are clipped at the edge of the pushing piece thorough holes 3-2. The front shell is also provided with four guiding columns 4-2, which pass through the pressure plate thorough holes 2-3, and between the guiding columns 4-2 and the pressure plate thorough holes 2-3 there may be a detachable connection, or a connection by means of a connecting column and a pushing piece.

An identification code can be attached to the front shell, the rear shell or the connection between the front shell and the rear shell, for example, when it is arranged at the connection between the front shell and the rear shell, in case of opening the front shell and the rear shell, it can be destroyed. An anti-counterfeiting film which has be a certain regular text or pattern is first attached to the outside of a product, then a portion of the anti-counterfeiting film is locked inside the front shell and the rear shell in case of closing the locking apparatus. Thus, even if the external anti-counterfeiting film is destroyed, resealing it does not enable the anti-counterfeiting film to fit with itself inside the locking apparatus.

In the present invention, the smart anti-counterfeiting apparatus of the Internet of Things may communicate with an user's mobile phone, and the user's mobile phone may communicate with the cloud server. During use, the mobile App actuates a code scanning function to scan the QR code on the bottle cap, then decodes the QR code, next after obtaining an ID, requests the back-end server to obtain the unlock information of the bottle cap corresponding to the ID through the network; if such a number does not exist in the back-end server, that presents the ID as a failure; if such a number exists in the back-end server but unlock information has occurred, that presents the ID as invalidity; if such a number exists in the back-end server and unlock information does not occur, the hardware information (Mac address) and unlock code of the apparatus and the SN number of the product are returned to the mobile App, which connects to the apparatus by means of Bluetooth via the Mac address, so as to send the unlock command (Connecting the mobile App with the hardware apparatus and sending demands need to verify the identity permission through AES128 encryption, if the identity verification is not passed, the hardware apparatus actively disconnects, and when the identity verification is passed, the App sends a corresponding unlock command to perform an unlocking operation.). When the App is informed of successful unlocking, it will submit the apparatus's Mac address and the product's SN number to the back-end server, then the back-end server sets the Mac address and the SN number to be an unlocked state, and returns to an invalid state at next scanning. Meanwhile, the hardware apparatus performs a destruction procedure after feedbacking the successful unlock information, so as to ensure no two-time utilization.

In the present invention, the smart anti-counterfeiting apparatus of the Internet of Things may also communicate with the cloud server, and an user's mobile phone may also communicate with the cloud server. During use, the mobile App actuates a code scanning function to scan the QR code on the bottle cap, then decodes the QR code, next after obtaining an ID, requests the back-end server to obtain the unlock information of the bottle cap corresponding to the ID through the network; if such a number does not exist in the back-end server, that presents the ID as a failure; if such a number exists in the back-end server but unlock information has occurred, that presents the ID as invalidity; if such a number exists in the back-end server and unlock information does not occur, the hardware information (Mac address) and unlock code of the apparatus and the SN number of the product are returned to the mobile App. The back-end server connects to the smart anti-counterfeiting apparatus of the Internet of Things by means of remote wireless connection via the Mac address, so as to send the unlock command. When the back-end server is informed of successful unlocking, it will sets the Mac address and the SN number to be an unlocked state, and returns to an invalid state at next scanning. Meanwhile, the hardware apparatus performs a destruction procedure after feedbacking the successful unlock information, so as to ensure no two-time utilization.

### Example 2

As shown in FIG. 5, the present invention can be applied to an anti-counterfeiting apparatus for wine, which is installed at a bottle cap and may be designed to be a completely detachable structure. The outside of the bottle has an encapsulated anti-counterfeiting film, the internal thread hole 3-1 of the pushing piece is connected with the external thread 1-2 of the motor on the rear shell, and the pressure plate 2 is connected with the pushing piece 3 by means of the receiving structure 2-1; then the rear shell 1, the pushing piece 3 and the pressure plate 2 that have been connected together are assembled and connected with the front shell 4 at an appropriate position of the product that needs to be anti-counterfeited, the connecting column 4-1 of the front shell fits and is connected with the pushing piece thorough hole 3-2, and the end of the connecting column 4-1 is a step structure; in case that the connecting column 4-1 of the front shell passes through the pushing piece thorough hole 3-2, the step structure at the end of the connecting column 4-1 will be jammed in the pushing piece thorough hole 3-2, and enables the smart anti-counterfeiting apparatus of the Internet of Things to lock a portion of the anti-counterfeiting film after installation; after the motor receives unlock information, the output shaft of the motor rotates in an unidirectional direction to drive the pushing piece 3, which cannot rotate under the position limit of the pressure plate 2, to move transversely relative to the motor, the rear end of the connecting column 4-1 of the front shell is jammed in the pushing piece thorough hole 3-2, meanwhile the front shell 4 moves transversely relative to the motor and the rear shell 1 until the rear shell 1 separates from the pushing piece 3 and the front shell 4; thus the smart anti-counterfeiting apparatus of the Internet of Things is opened; meanwhile, the pushing piece 3 and the front shell 4 are still connected together, the connecting column 4-1 of the front shell is still jammed in the pushing piece thorough hole 3-2, the pressure plate receiving structure 2-1 still limits the pushing piece 3, so that the internal thread hole 3-1 of the pushing piece cannot be connected with the external thread 1-2 of the motor on the rear shell again.

### Example 3

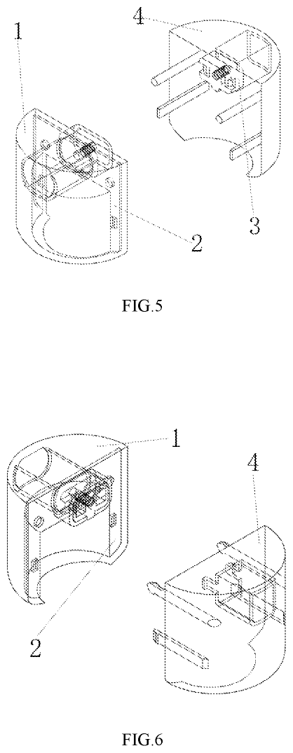

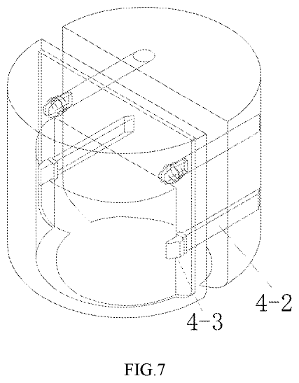

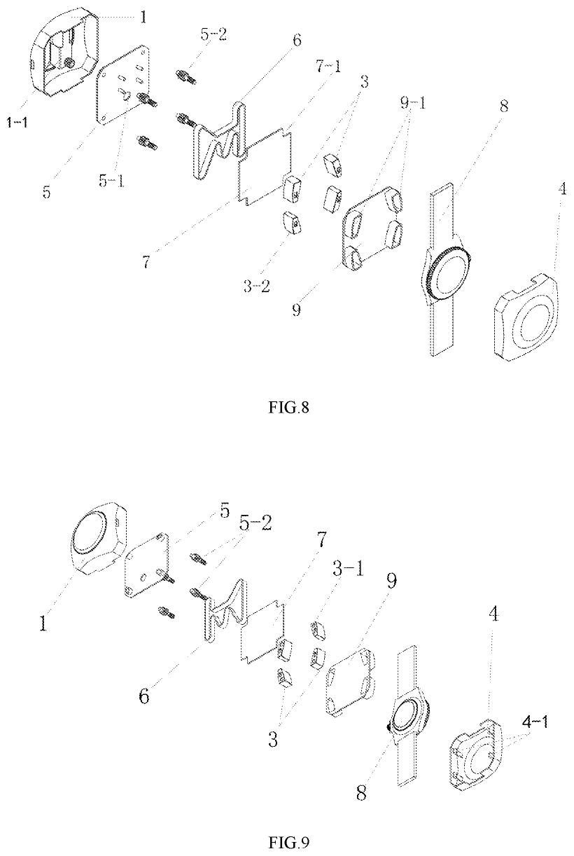

As shown in FIGS. 6 and 7, the present invention can be applied to an anti-counterfeiting apparatus for wine, which is installed at a bottle cap and may be designed to be an incompletely-detachable structure. The outside of the bottle has an encapsulated anti-counterfeiting film, the internal thread hole 3-1 of the pushing piece is connected with the external thread 1-2 of the motor on the rear shell, and the pressure plate 2 is connected with the pushing piece 3 by means of the receiving structure 2-1, the guiding column of the rear shell passes through the pressure plate thorough hole; then the rear shell 1, the pushing piece 3 and the pressure plate 2 that have been connected together are assembled and connected with the front shell 4 at an appropriate position of the product that needs to be anti-counterfeited, the connecting column 4-1 of the front shell fits and is connected with the pushing piece thorough hole 3-2, and the end of front portion of the connecting column 4-1 is a step structure; in case that the connecting column 4-1 of the front shell passes through the pushing piece thorough hole 3-2, the step structure at the end of the connecting column 4-1 will be jammed in the pushing piece thorough hole 3-2, and enables the smart anti-counterfeiting apparatus of the Internet of Things to lock a portion of the anti-counterfeiting film after installation; after the motor receives unlock information, the output shaft of the motor rotates in an unidirectional direction to drive the pushing piece 3, which cannot rotate under the position limit of the pressure plate 2, to move transversely relative to the motor, the rear end of the connecting column 4-1 of the front shell is jammed in the pushing piece thorough hole 3-2, meanwhile the front shell 4 moves transversely relative to the motor and the rear shell 1 until the guiding column end 4-3 is jammed in the pressure plate thorough hole 2-3; the guiding column end 4-3 is a step structure, so that the pushing piece and the front shell move over a distance relative to the rear shell; thus the smart anti-counterfeiting apparatus of the Internet of Things is opened; meanwhile, the pushing piece 3 and the front shell 4 are still connected together, the connecting column 4-1 of the front shell is still jammed in the pushing piece thorough hole 3-2, the pressure plate receiving structure 2-1 still limits the pushing piece 3, so that the internal thread hole 3-1 of the pushing piece cannot be connected with the external thread 1-2 of the motor on the rear shell again.

### Example 4

As shown in FIGS. 8 and 9, the present invention can be applied to an anti-counterfeiting apparatus for watches, which includes the rear shell 1, the facility pressure plate 5, the annular transmission toothed belt 6, the transmission compartment pressure plate 7, four pushing pieces 3, the guiding pressure plate 9 and the front shell 4, wherein the motor 1-1 is arranged on the rear shell, a gear is instated on the output shaft of the motor, four transmission screws 5-2 on which gears are installed are arranged on the facility pressure plate 5, the output shaft of the motor passes through the facility pressure plate 5, the gear of the output shaft of the motor meshes with the annular transmission toothed belt 6, which simultaneously meshes with the four transmission screws 5-2 arranged on the facility pressure plate 5, the transmission compartment pressure plates 7 are arranged above the annular transmission toothed belt 6, the transmission compartment pressure plate gap 7-1 composed of a hole or a groove or a notch is arranged on the transmission compartment pressure plate 7, the transmission screw 5-2 passes through the transmission compartment pressure plate gap 7-1 and is connected to the internal threaded hole 3-1 of the pushing piece, several protuberant guiding pressure plate receiving structures 9-1 are arranged on the guiding pressure plates 9, the inner cavities of the protuberant guiding pressure plate receiving structures fit with the pushing pieces 3 to limit the rotation of the pushing pieces 3, several connecting columns 4-1 are arranged inside the front shell 4, and the connecting columns 4-1 fit with the pushing piece thorough holes 3-2, the end of the connecting column is a step structure, which can be jammed in the pushing piece thorough hole 3-2 after the connecting column is inserted into the pushing piece thorough hole 3-2.

Its installation and use method is as follows:
a. A facility pressure plate cover is above the rear shell 1, and the output shaft of the motor of the rear shell 1 passes through the facility pressure plate 5.
b. The annular transmission toothed belt 6 is installed above the facility pressure plate cover, meshes with the gear of the output shaft of the motor, and simultaneously meshes with the gears of several transmission screws 5-2, and the output shaft of the motor rotates to drive all transmission screws 5-2 to rotate.
c. The transmission compartment pressure plate 7 is installed above the annular transmission toothed belt 6, and the transmission screw 5-2 is connected to the pushing piece 3 through the transmission compartment pressure plate 7.
d. The pushing piece 3 is assembled and connected with the guiding pressure plate receiving structure 9-1.
e. The pushing piece 3 is connected with the front shell 4 at an appropriate position of the product that needs to be anti-counterfeited, so as to close the apparatus.
f. During operation, the output shaft of the motor rotates and drives the transmission screws 5-2 to rotate, then the rotation of the transmission screws 5-2 enables the guiding pressure plate 9 to limit the rotation of the pushing piece 3, the transmission screws 5-2 rotate to drive the pushing piece 3 to move upwards, the pushing piece 3 moves upwards together with the front shell 4 under the action of the connecting column 4-1, so that the rear shell 1 separates from the pushing piece 3 and the front shell 4, the facility pressure plate 5, the annular transmission toothed belt 6 and the transmission compartment pressure plate 7, so as to open the apparatus. Meanwhile, the pushing piece 3 cannot rotate separately under the position limit of the guiding pressure plate 9, nor separate from the guiding pressure plate and the front shell under the position limit of the connecting column, so the anti-counterfeiting apparatus cannot be closed again.

### Example 5

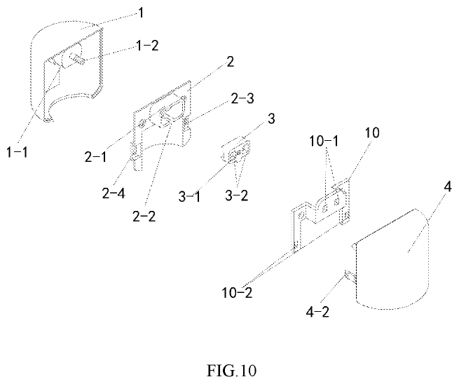

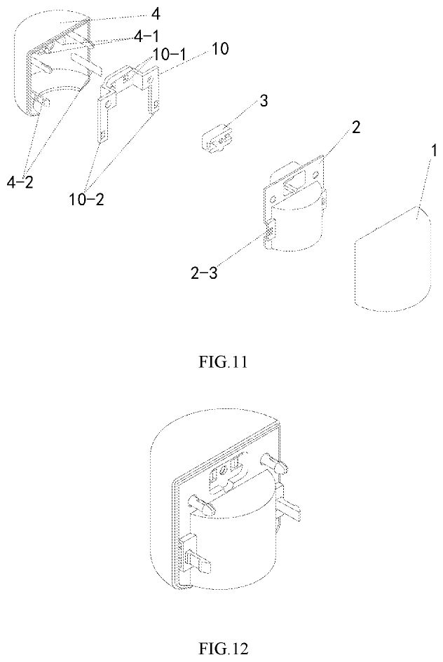

As shown in FIGS. 10-12, the present invention makes an improvement to the structure of Example 1, wherein the motor 1-1 and a PCB control board are arranged in the cavity of the back shell 1, a battery to power the motor and the PCB control board or a preset charging interface to power the motor and the PCB control board from an external power supply may be arranged inside the rear shell, and a chip having an independent MAC address is also arranged on the PCB control board.

One side of the front portion of the pressure plate 2 according to the present invention is the outward-convex receiving structure 2-1 inside which a cavity is arranged, the rabbet 2-2 is further arranged at one side of the cavity, several pressure plate thorough holes 2-3 are arranged on the pressure plate, four guiding holes 2-4 are opened on the pressure plate 2, two guiding holes 2-4 are arranged on both sides of the lower portion of the pressure plate 2, and the groove in the lower portion of the pressure plate in this example is used to fit with the bottle cap.

The internal thread hole 3-1 used to fit with the output shaft of the motor of the rear shell is arranged at the middle portion of the pushing piece 3 according to the present invention, two pushing piece thorough holes 3-2 are arranged inside the pushing piece, and the positioning piece 3-3 is arranged at the bottom of the pushing piece.

In the present invention, two connecting columns 4-1 are arranged inside the front shell 4, the connecting column 4-1 and the pushing piece thorough hole 3-2 are connected with each other, the end of the connecting column 4-1 is a step structure, the cross-sectional area of the front end of which is less than the cross-sectional area of its rear end, after the connecting column 4-1 passes through the pushing piece thorough hole 3-2, the rear end of the connecting column 4-1 is clipped at the edge of the pushing piece through hole 3-2. The front shell is also provided with four guiding columns 4-2, the ends of the upper two guiding columns 4-3 are a step structure, after the guiding column 4-2 passes through the pressure plate thorough hole 2-3, the step structure at the guiding column end 4-3 is jammed in the pressure plate thorough hole 2-3, the ends and middle portions of the lower two guiding column both are a step structure, the step structure of the ends fits with a pressure plate guiding hole, and the step structure of the middle portions fits with a clamping plate guiding hole.

In the present invention, the clamping plate 10 is arranged between the front shell 4 and the pressure plate 2, several clamping plate thorough holes 10-1 and several clamping plate guiding holes 10-2 which correspond to the pushing piece thorough-hole 3-2 and the guiding column 4-2 of the front shell, respectively, are arranged on the clamping plate 10, and the step structure at the middle portion of the guiding column 4-2 on the front shell 4 only fits with the clamping plate guiding hole 10-2.

An identification code can be attached to the front shell, the rear shell or the connection between the front shell and the rear shell, for example, when it is arranged at the connection between the front shell and the rear shell, in case of opening the front shell and the rear shell, it can be destroyed. An anti-counterfeiting film which has be a certain regular text or pattern is first attached to the outside of a product, then a portion of the anti-counterfeiting film is locked inside the front shell and the rear shell in case of closing the locking apparatus. Thus, even if the external anti-counterfeiting film is destroyed, resealing it does not enable the anti-counterfeiting film to fit with itself in the locking apparatus.

The present invention can be applied to an anti-counterfeiting apparatus for wine, which is installed at a bottle cap and may be designed to be an incompletely-detachable structure. The outside of the bottle has an encapsulated anti-counterfeiting film, the internal thread hole 3-1 of the pushing piece is connected with the external thread 1-2 of the motor on the rear shell, and the pressure plate 2 is connected with the pushing piece 3 by means of the receiving structure 2-1; the clamping plate guiding hole 10-2 is aligned with the guiding holes 2-4 of the pressure plate 2, then the rear shell 1, the pushing piece 3, the pressure plate 2 and the clamping plate 10 that have been connected together are assembled and connected with the front shell 4 at an appropriate position of the product that needs to be anti-counterfeited, the connecting column 4-1 of the front shell fits and is connected with the pushing piece thorough hole 3-2, and the end of the connecting column 4-1 is a step structure; in case that the connecting column 4-1 of the front shell passes through the pushing piece thorough hole 3-2, the step structure at the end of the connecting column 4-1 will be jammed in the pushing piece thorough hole 3-2; the guiding column 4-2 of the front shell 4 passes through the pressure plate 2 and the clamping plate guiding hole 10-2, then the step structure set at the guiding column end 4-3 clips the pressure plate 2 after passing through the clamping plate guiding hole 10-2, furthermore, a step structure is arranged at the end and the middle portion end of at least one guiding column 4-2, the step structure at the middle portion of the guiding column clips the clamping plate 10 after passing through the clamping plate guiding hole 10-2, and enables the smart anti-counterfeiting apparatus of the Internet of Things to lock a portion of the anti-counterfeiting film after installation; after the motor receives unlock information, the output shaft of the motor rotates in an unidirectional direction to drive the pushing piece 3, which cannot rotate under the position limit of the pressure plate 2, to move transversely relative to the motor, the rear end of the connecting column 4-1 of the front shell is jammed in the pushing piece thorough hole 3-2, the step structure at the middle portion of the guiding column of the front shell 4 is jammed in the clamping plate guiding hole 10-2; meanwhile the front shell 4 and the clamping plate 10 also move transversely relative to the motor and the rear shell 1 until the guiding column end 4-3 is jammed in the pressure plate thorough hole 2-3, so that the pushing piece 3 and the front shell 4 move over a distance relative to the rear shell 1, thus the smart anti-counterfeiting apparatus of the Internet of Things is opened; meanwhile, the pushing piece 3 and the front shell 4 are still connected together, the connecting column 4-1 of the front shell is still jammed in the pushing piece thorough hole 3-2, the guiding column of the front shell 4 is still jammed in the clamping plate guiding hole 10-2, the pressure plate receiving structure 2-1 still limits the pushing piece 3, so that the internal thread hole 3-1 of the pushing piece cannot be connected with the external thread 1-2 of the motor on the rear shell again.

### Example 6

The present invention can be applied to an anti-counterfeiting apparatus for wine, which is installed at a bottle cap and may be designed to be a completely-detachable structure. The outside of the bottle has an encapsulated anti-counterfeiting film, the internal thread hole 3-1 of the pushing piece 3 is connected with the external thread 1-2 of the motor on the rear shell 1, and the pressure plate 2 is connected with the pushing piece 3 by means of the receiving structure 2-1; the clamping plate guiding hole 10-2 is aligned with the guiding holes 2-4 of the pressure plate 2, then the rear shell 1, the pushing piece 3, the pressure plate 2 and the clamping plate 10 that have been connected together are assembled and connected with the front shell 4 at an appropriate position of the product that needs to be anti-counterfeited, the connecting column 4-1 of the front shell fits and is connected with the pushing piece thorough hole 3-2, and the end of the connecting column 4-1 is a step structure; in case that the connecting column 4-1 of the front shell passes through the pushing piece thorough hole 3-2, the step structure at the end of the connecting column 4-1 will be jammed in the pushing piece thorough hole 3-2; the guiding column 4-2 of the front shell 4 passes through the pressure plate 2 and the clamping plate guiding hole 10-2, the step structure arranged at the middle portion end of at least one guiding column 4-2 clips the clamping plate 10 after passing through the clamping plate guiding hole 10-2, and enables the smart anti-counterfeiting apparatus of the Internet of Things to lock a portion of the anti-counterfeiting film after installation; after the motor receives unlock information, the output shaft of the motor rotates in an unidirectional direction to drive the pushing piece 3, which cannot rotate under the position limit of the pressure plate 2, to move transversely relative to the motor, the rear end of the connecting column 4-1 of the front shell is jammed in the pushing piece thorough hole 3-2, the step structure at the middle portion of the guiding column 4-2 of the front shell 4 is jammed in the clamping plate guiding hole 10-2; meanwhile the front shell 4 and the clamping plate 10 also move transversely relative to the motor and the rear shell 1 until the rear shell 1 separates from the pushing piece 3 and the front shell 4, thus the smart anti-counterfeiting apparatus of the Internet of Things is opened; meanwhile, the pushing piece 3 and the front shell 4 are still connected together, the connecting column 4-1 of the front shell is still jammed in the pushing piece thorough hole 3-2, the guiding column 4-2 of the front shell 4 is still jammed in the clamping plate guiding hole 10-2, the pressure plate receiving structure 2-1 still limits the pushing piece 3, so that the internal thread hole 3-1 of the pushing piece cannot be connected with the external thread 1-2 of the motor on the rear shell again.

1. A smart anti-counterfeiting apparatus of the Internet of Things, at least comprising:
an independent identification code;
a PCB board, which is used to control a motor, and on which is arranged a chip having an independent MAC address;
and a locking apparatus only capable of one-time opening after closing;
wherein, said locking apparatus includes:
a rear shell (1), inside which is arranged a motor (1-1), on the output shaft of which an external thread (1-2) is arranged;
a pushing piece (3), the middle portion of which is provided with an internal thread hole (3-1) to fit with the output shaft of the motor, and inside which there are several pushing piece thorough holes (3-2);
a pressure plate (2), on which is arranged an outward convex receiving structure (2-1) provided with a cavity to fit with the shape of said pushing piece (3) and used to prevent the rotation trend of said pushing piece (3); and
a front shell (4), inside which are arranged several connecting columns (4-1) which fit with the pushing piece thorough holes (3-2), and the end of connecting columns (4-1) being a step structure which is jammed in the pushing piece thorough holes (3-2) after the connecting columns (4-1) pass through the push piece thorough holes (3-2).

2. The smart anti-counterfeiting apparatus of the Internet of Things according to claim 1,
wherein the pressure plate (2), on which is arranged the outward convex receiving structure (2-1) provided with the cavity to fit with the shape of said pushing piece (3) and used to prevent the rotation trend of said pushing piece (3), and on which are arranged several guiding the holes (2-4); at least one guiding the holes (2-4) being arranged in the lower portion of said pressure plate (2);
the front shell (4), inside which are arranged the several connecting columns (4-1) and several guiding columns (4-2); the connecting columns (4-1) fitting with the pushing piece thorough holes (3-2), the end of the connecting columns (4-1) being a step structure which is jammed in the pushing piece thorough the holes (3-2) after the connecting columns (4-1) pass through the push piece thorough the holes (3-2), at least one guiding columns (4-2) being arranged in the lower portion of said front shell (4) and fitting with the position of the guiding hole of said pressure plate (2), and the middle portion of at least one guiding columns (4-2) being provided with a step structure; and
a clamping plate (10), which is arranged between said front shell (4) and said pressure plate (2), and on which are arranged several clamping plate through-holes (10-1) and several clamping plate guiding holes (10-2) which correspond to the pushing piece thorough-holes (3-2) and the guiding columns (4-2) of said front shell, respectively; the step structure at the middle portion of the guiding columns (4-2) of said front shell only fitting with the clamping plate guiding holes (10-2).

3. The smart anti-counterfeiting apparatus of the Internet of Things according to claim 2, wherein a battery or a charging interface is arranged inside said smart anti-counterfeiting apparatus of the Internet of Things; a positioning piece (3-3) fitting with the rabbet (2-2) of a pressure plate receiving structure is arranged inside said pushing piece (3).

4. The smart anti-counterfeiting apparatus of the Internet of Things according to claim 1, wherein several guiding columns (4-2) are further arranged inside said front shell (4), and several corresponding pressure plate thorough holes (2-3) are arranged on said pressure plate (2).

5. The smart anti-counterfeiting apparatus of the Internet of Things according to claim 1, wherein the end of the guiding column (4-2) is a step structure, and after the guiding column (4-2) passes through the pressure plate thorough hole (2-3), the step structure at the guiding column end (4-3) is jammed in the pressure plate thorough hole (2-3).

6. The smart anti-counterfeiting apparatus of the Internet of Things according to claim 2, wherein the end of the guiding column (4-2) is a step structure, and after the guiding column (4-2) passes through the pressure plate thorough hole (2-3), the step structure at the guiding column end (4-3) is jammed in the pressure plate thorough hole (2-3), the end and middle portion of at least one guiding column (4-2) are both a step structure, the step structure of the end fits with a pressure plate guiding hole (2-4), and the step structure of the middle portion fits with the clamping plate guiding hole (10-2).

7. The smart anti-counterfeiting apparatus of the Internet of Things according to claim 2, wherein said anti-counterfeiting apparatus further includes an anti-counterfeiting film; the motor is a unidirectional motor; and said smart anti-counterfeiting apparatus of the Internet of Things also includes an independent SN code; and said identification code is arranged at the junction of said front shell and said rear shell.

8. An anti-counterfeiting method of the smart anti-counterfeiting apparatus of the Internet of Things according to claim 2, comprising the following steps:
S1, scanning said independent identification code of the smart anti-counterfeiting apparatus of the Internet of Things through an user's mobile terminal;
S2, obtaining an ID number, then requesting a back-end server to unlock through the network;
S3, enabling the back-end server to process the information of the ID number, if such a number does not exist in the back-end server, presenting the ID as a failure; if such a number exists in the back-end server but unlock information has occurred, presenting the ID as invalidity; if such a number exists in the back-end server and unlock information does not occur, returning the hardware information, Mac address, SN number and unlock code of the smart anti-counterfeiting apparatus of the Internet of Things to the user's mobile terminal;
S4, enabling the user's mobile terminal to connect to the smart anti-counterfeiting apparatus of the Internet of Things and send an unlock command by means of wireless connection through the Mac address; and
S5, enabling the back-end server to set the Mac address and the SN number to be an unlocked state after informed of successful unlocking, and return to an invalid state at next scanning, meanwhile enabling the hardware apparatus to perform a destruction procedure after feedbacking successful unlock information, so as to ensure no two-time utilization.

9. The anti-counterfeiting method of the smart anti-counterfeiting apparatus of the Internet of Things according to claim 8, wherein
in the step S4, enabling the user's mobile terminal to connect to the smart anti-counterfeiting apparatus of the Internet of Things and send an unlock command by means of wireless connection through the Mac address, and verifying the identity permission through encryption required for the connection of the user's mobile terminal with the smart anti-counterfeiting apparatus of the Internet of Things and the dispatch of commands; and
in the step S5, enabling the user's mobile terminal to submit the apparatus's Mac address and the SN number to the back-end server after informed of successful unlocking, then the back-end server to set the Mac address and the SN number to be an unlocked state, and return to an invalid state at next scanning, meanwhile enabling the hardware apparatus to perform a destruction procedure after feedbacking successful unlock information, so as to ensure no two-time utilization.

10. The anti-counterfeiting method of the smart anti-counterfeiting apparatus of the Internet of Things according to claim 8, further comprising the following steps:
a, encapsulating an anti-counterfeiting film on the outside of a product to be anti-counterfeited;
b, connecting the internal thread hole (3-1) of said pushing piece (3) with the external thread (1-2) of the motor on said rear shell (1), and matching and connecting said pressure plate (2) with said pushing piece (3) by means of the receiving structure (2-1);
c, assembling and connecting said rear shell (1), said pushing piece (3) and said pressure plate (2) that have been connected together with said front shell (4) at an appropriate position of the product that needs to be anti-counterfeited, matching and connecting the connecting column (4-1) of said front shell with the pushing piece thorough hole (3-2), enabling the end of the connecting column (4-1) to be a step structure, in case that the connecting column (4-1) of said front shell passes through the pushing piece thorough hole (3-2), jamming the step structure at the end of the connecting column (4-1) in the pushing piece thorough hole (3-2) to enable the smart anti-counterfeiting apparatus of the Internet of Things to lock a portion of the anti-counterfeiting film after installation;
d, after the motor receives unlock information, enabling the output shaft of the motor to rotate in an unidirectional direction to drive said pushing piece (3), which cannot rotate under the position limit of said pressure plate (2), to move transversely relative to the motor, jamming the rear end of the connecting column (4-1) of said front shell in the pushing piece thorough hole (3-2), meanwhile enabling said front shell (4) to move transversely relative to the motor and said rear shell (1) until said pushing piece (3) and said front shell (4) separate from said rear shell (1); thus opening the smart anti-counterfeiting apparatus of the Internet of Things; and
e, at this time, still connecting said pushing piece (3) together with said front shell (4), still jamming the connecting column (4-1) of said front shell in the pushing piece thorough hole (3-2), stilling putting said pushing piece (3) under the position limit of the pressure plate receiving structure (2-1), so that the internal thread hole (3-1) of said pushing piece cannot be connected with the external thread (1-2) of the motor on said rear shell again.

11. The anti-counterfeiting method of the smart anti-counterfeiting apparatus of the Internet of Things according to claim 10, wherein
in step b, further including aligning the clamping plate guiding hole (10-2) with the guiding holes (2-4) of said pressure plate (2);
in step c, assembling and connecting said rear shell (1), said pushing piece (3), said pressure plate (2) and said clamping plate (10) that have been connected together with said front shell (4) at an appropriate position of the product that needs to be anti-counterfeited; enabling the guiding column (4-2) of said front shell (4) to pass through said pressure plate (2) and the clamping plate guiding hole (10-2), and arranging a step structure capable of clipping said clamping plate (10) after passing through the clamping plate guiding hole (10-2), at the middle portion of at least one guiding column (4-2), so that the smart anti-counterfeiting apparatus of the Internet of Things locks a portion of the anti-counterfeiting film after installation;
in step e, at this time, still connecting said pushing piece (3) together with said front shell (4), still jamming the connecting column (4-1) of said front shell in the pushing piece thorough hole (3-2), still jamming the guiding column (4-2) of said front shell in the clamping plate guiding hole (10-2), stilling putting said pushing piece (3) under the position limit of the pressure plate receiving structure (2-1), so that the internal thread hole (3-1) of said pushing piece cannot be connected with the external thread (1-2) of the motor on said rear shell again.

12. A smart anti-counterfeiting apparatus of the Internet of Things, at least comprising:
an independent identification code;
a PCB board, which is used to control a motor, and on which is arranged a chip having an independent MAC address;
and a locking apparatus only capable of one-time opening after closing;
wherein, said locking apparatus includes:
a rear shell (1), inside which a motor (1-1) is arranged;
a facility pressure plate (5), on which is arranged a facility pressure plate thorough hole (5-1) used to let the output shaft of the motor to pass through, and on which are arranged several transmission screws (5-2) driven through the interactional movement between the output shaft of the motor and a transmission apparatus;
several pushing pieces (3), inside which is arranged an internal threaded hole (3-1) fitting with the transmission screw (5-2), and on which several pushing piece thorough holes (3-2) are arranged;
a guiding pressure plate (9), on which are arranged several protuberant guiding pressure plate receiving structure (9-1) the inner cavities of which fit with the pushing pieces (3) so as to limit the rotation of the pushing pieces (3); and
a front shell (4), inside which are arranged several connecting columns (4-1) which fit with the pushing piece thorough holes (3-2), and the end of connecting columns (4-1) being a step structure which is jammed in the pushing piece thorough holes (3-2) after the connecting columns (4-1) pass through the push piece thorough holes (3-2).

13. The smart anti-counterfeiting apparatus of the Internet of Things according to claim 12, wherein the transmission apparatus is an annular transmission toothed belt (6), which meshes with the gear of the output shaft of the motor, and simultaneously meshes with the gears of several transmission screws (5-2).

14. The smart anti-counterfeiting apparatus of the Internet of Things according to claim 12, wherein said anti-counterfeiting apparatus further includes a transmission compartment pressure plate (7), the annular transmission toothed belt (6) simultaneously meshes with four transmission screws (5-2) arranged on said facility pressure plate (5), the transmission compartment pressure plates (7) are arranged above the annular transmission toothed belt (6), a transmission compartment pressure plate gap (7-1) composed of a hole or a groove or a notch is arranged on the transmission compartment pressure plate (7), the transmission screws (5-2) pass through the transmission compartment pressure plate gap (7-1) and are connected to the internal threaded hole (3-1) of said pushing piece.

15. The smart anti-counterfeiting apparatus of the Internet of Things according to claim 12, wherein a battery or a charging interface is arranged inside said smart anti-counterfeiting apparatus of the Internet of Things.

16. The smart anti-counterfeiting apparatus of the Internet of Things according to claim 12, wherein said anti-counterfeiting apparatus further includes an anti-counterfeiting film.

17. The smart anti-counterfeiting apparatus of the Internet of Things according to claim 12, wherein the motor is a unidirectional motor.

18. The smart anti-counterfeiting apparatus of the Internet of Things according to claim 12, wherein said smart anti-counterfeiting apparatus of the Internet of Things also includes an independent SN code.

19. The smart anti-counterfeiting apparatus of the Internet of Things according to claim 12, wherein said identification code is arranged at the junction of said front shell and said rear shell.

20. The smart anti-counterfeiting apparatus of the Internet of Things according to claim 12, wherein a process for using the smart anti-counterfeiting apparatus of the Internet of Things by the following steps:
a, putting a facility pressure plate cover above said rear shell (1), and enabling the output shaft of the motor of said rear shell (1) to pass through said facility pressure plate (5);
b, installing the annular transmission toothed belt (6) above the facility pressure plate cover, meshing the annular transmission toothed belt (6) with the gear of the output shaft of the motor, and simultaneously with the gears of several transmission screws (5-2), and enabling the output shaft of the motor to rotate, so as to drive all transmission screws to rotate;
c, installing the transmission compartment pressure plate (7) above the annular transmission toothed belt (6), and connecting the transmission screw (5-2) to said pushing piece (3) through the transmission compartment pressure plate (7);
d, assembling and connecting said pushing piece (3) with the guiding pressure plate receiving structure (9-1); and
e, connecting the pushing piece (3) with said front shell (4) at an appropriate position of the product that needs to be anti-counterfeited, so as to close the apparatus; during operation, enabling the output shaft of the motor to rotate and drive the transmission screws (5-2) to rotate, enabling the guiding pressure plate (9) to limit the rotation of said pushing piece (3) through the rotation of the transmission screws (5-2), enabling the transmission screws (5-2) to rotate to drive said pushing piece (3) to move upwards, and enabling said pushing piece (3) to move upwards together with said the clamping plate (9) and said front shell (4) under the action of the connecting column (4-1), so that said pushing piece (3) and said front shell (4) separate from said rear shell (1), said facility pressure plate (5), the annular transmission toothed belt (6) and the transmission compartment pressure plate (7), so as to open the apparatus, at this time, still connecting said pushing piece (3) together with said front shell (4), still jamming the connecting column (4-1) of said front shell in the pushing piece thorough hole (3-2), stilling putting said pushing piece (3) under the position limit of the pressure plate receiving structure (2-1), so that the internal thread hole (3-1) of said pushing piece cannot be connected with the external thread (1-2) of the motor on said rear shell again.
